(19) United States
(12) Patent Application Publication
(10) Pub. No.: US 2006/0015357 A1
(43) Pub. Date: Jan. 19, 2006

(54) Method and apparatus for spatiotemporal valuation of real estate

(75) Inventor: Christopher L. Cagan, Los Angeles, CA (US)

Correspondence Address: Marshall A. Lerner, Esq.;Kleinberg & Lerner, LLP, Suite 1080, 2049 Century Park East, Los Angeles, CA, 90067, US

(73) Assignee: First American Real Estate Solutions, L.P.

(21) Appl. No.: 10/892,618

(22) Filed: Jul. 16, 2004

(51) Int. Cl. G06Q 99/00

(52) U.S. Cl. 705/1

(57) ABSTRACT

A method and apparatus for valuing every property in a predetermined geographic region at regular intervals and storing those valuations for ready access later in a layered data stratum, using customary sources of property valuation data to create a new layers of the data stratum and using the data stored in the one or more layers of the data stratum for the creation of tables, spreadsheets and maps for evaluations of changes and trends in property valuation.

### BACKGROUND OF THE INVENTION

1. Field of the Invention

The present invention relates generally to methods and apparatus for valuing property and, more specifically, to a method and apparatus for valuing all of the real estate in a geographic area using an automated valuation model.

2. Description of Prior Art

Many real estate lenders and professionals need to receive accurate valuations of a property, such as a single-family residence. A single-family residence could be a detached house, a townhouse, or a condominium. The reasons for these valuations are various. For example, mortgage lenders need to evaluate property with reasonable accuracy in order to ensure that they do not over lend to someone based upon insufficient value in a property. Alternatively, real estate professionals may simply want an accurate valuation of a property in order to know a proper purchasing price for it. On a collective basis, many people would like to know about trends in price and value for collective data sets such as the residences in a census tract, zip code, city, county, or state. The primary focus of this invention is to provide spatiotemporal understanding of the valuations of individual properties or larger sets of properties to lenders and real estate professionals. The invention may also have other applications.

Because of the need for accurate valuations of property, many methods have arisen to address this need. The most common and oldest method involves the employment of an appraiser. This method, while usually fairly accurate, is often the most expensive method. In addition to the high cost, appraisals can take up to two weeks to schedule and complete. Finally, the property value given by an appraiser can vary, sometimes erratically, depending on the comparable properties chosen in performing the appraisal. It is financially impossible to appraise all the residences in a zip code, county, or state; hence appraisals cannot be used to make exhaustive studies of large collective sets.

Another common method involves the study of the prices of sold properties according to zip code, city, county or state. One disadvantage of this method is that the number of properties sold within a zip code during a month is often quite small, thus producing erratic variations in mean or median price levels.

More recently, automated valuation models have come into vogue. These models utilize computer and mathematical models in order to accurately value a property based upon many comparable properties. The advantages of automated valuation models are many. Most notably, they can be done almost instantly at relatively low cost. Automated valuation models, when implemented effectively, also provide accurate valuations. These models allow real estate agents to quickly estimate the value of homes offered within their portfolio or for sale upon the open market. They also enable mortgage refinancing companies to target individuals more effectively who have significant equity in their homes. They enable lenders to quickly estimate the value of homes upon which they are asked to lend for mortgages.

The present invention uses the advantages in speed and cost of automated valuation models to produce large and nearly exhaustive data stratum layers which in turn yield new products and understandings when valuations are studied with respect to space and time, on an individual or a collective basis.

There exist some commonly used ways of arriving at a spatial and temporal (spatiotemporal) understanding of real estate valuation, which can be used in valuation of individual properties or in the understanding of price trends within geographic areas or in the understanding of price differences across different geographic areas.

The existing methods are based on a small stratum of sold or appraised properties in a certain geographic area. Unfortunately, only a small percentage of the properties in an area are actually sold during a typical period of time such as a month or a year. It is often the case for small geographical zones and small time intervals that there were no properties sold. Thus, valuations, geographic studies, time-based price indices, and other applications all suffer from the problem of data set sizes which can be very small—or sometimes literally zero.

One approach to dealing with this problem is to sacrifice temporal (time) precision and specificity and look at a long period of time such as an entire year, in order to increase the number of sold or appraised properties available for consideration. Another approach is to sacrifice spatial (geographic) precision and look at large geographic areas such as entire counties, at the cost of missing local differences.

Neither one of these sacrifices is optimal. Generally, the smallness of the data sets makes it impossible to construct good indices or maps of price differences or changes for individual zip codes done month by month. The number of sold properties in a zip code during a month may be well under ten—or actually zero. More reliable numbers can be obtained by making sacrifices such as studying zip codes by year—or counties by month—but neither procedure is optimal. In both cases the sacrifices made are considerable.

The present invention has the virtue of being able to work with spatial and temporal distinctions at a much finer level than existing procedures, since it is possible to carry out automated valuations of all (or almost all) of the property stock in an area at regular intervals such as quarterly or monthly—regardless of whether the properties sold or not. This can increase the data set size by tenfold or even a hundredfold. It can also provide a large data set even in cases where no properties at all were sold.

### BRIEF SUMMARY OF THE INVENTION

According to the present invention, a method and apparatus are described whereby an automated valuation model is used to perform valuations for every property in a given region at predetermined time intervals. The valuation data is stored in a data-base for quick future reference and to be used as a data stratum in other applications. Additional data stratum layers are derived using automated valuation models as time moves forward, using information from recent sales and appraisals. In an alternative embodiment, prior data stratum layers may also themselves be used. Each layer of the data stratum may then be used to create visual maps or data tables that represent the values in a specific area or percentage changes in values for a specific area. In other embodiments, the entire data stratum could be used in many other ways to create data tables, graphs, or maps demonstrating any number of relations between property valuations.

In the preferred embodiment, the method begins with the use of an automated valuation model. Using whatever method the particular automated valuation model employs, the method requests a valuation of each and every property in a geographic region. In practice, the great majority of properties are successfully valued. Only a relatively few properties cannot be valued due to data difficulties or exceptions in property features or other reasons. Generally, the requested geographic region is very large to enable the data stratum to grow as large as possible. This will provide a large data set when using the data stratum to construct spatial, temporal, or other products. Next, using this method, the valuations given and the addresses or other unique identifiers are stored in a database. In alternative embodiments, information concerning many and various other property-related information may also be stored.

These valuations are stored for immediate access at a later date. Because the valuation of every, or almost every, property in a very large geographic area has already been run and the valuation stored, the user can request a valuation and receive it immediately. This method dramatically improves upon the prior art by lowering the cost and time necessary to perform a quick and accurate valuation. Additionally, the user can be assured that the valuation is relatively up-to-date. In the preferred embodiment, the regular valuations would be performed every month. In this embodiment, the user could be assured of the accuracy of the valuation in that the property had been valued within the last month.

Over time, the valuation data that is stored will create a series of data stratum layers. Each “layer” of data stratum will be a set of automated valuation model valuations for all, or almost all, of the properties in the geographic area. In the preferred embodiment, each of these data stratum layers will be created using only automated valuation models based on recent sales and appraisals. Alternatively, when the data stratum is updated each additional time, it could also use these sources and an already existing data stratum layer to create an even more accurate picture of the property values for every home in the area.

These series of data stratums may be used to do more than provide valuations of every property in a geographic area. The series of data stratums is also useful as a tool for analysis of trends, differences, and patterns in valuation in much smaller time-periods and geographic areas than has ever been possible. Furthermore, a data stratum or series of data stratums can be used to find particular areas of highly valued property within an area of low valuation. It can be used to find low-valued property in the midst of more expensive property for potential purchasers hoping to gain through investing in real estate. The data stratum can be used to determine the percent increase or decrease in valuation for various geographic areas. The data stratum can be used to determine the actual increase or decrease in valuation as measured in dollars for various geographic areas. Numerous other applications are available once the data stratum has been collected. Finally, the data stratum can be employed to create maps, tables, graphs, and “movies” across space and time of each of the above mentioned comparisons and trends. These visual representations of sections of this immense data stratum can be quickly scanned for useful information.

Because the size of the data set is much larger, all of these applications can be generated at a much higher level of spatial and temporal precision than was hitherto possible. Moreover, since valuations can still be generated even in the absence of very recent or very nearby sales, it is possible to generate applications even for areas and periods of no sales where prior methods would be unable to produce any information or application at all.

Further features and advantages of the present invention will be appreciated by reviewing the following drawings and

### DETAILED DESCRIPTION OF THE INVENTION

### BRIEF DESCRIPTION OF THE DRAWINGS

FIG. 1 is an overview of the spatiotemporal valuation processor.

FIG. 2 is an overview of a scheduled update of the data stratum.

FIG. 3 is an overview of a user valuation request.

FIG. 4 is the data stratum in the preferred embodiment.

FIG. 5 is a potential data stratum in an alternative embodiment.

FIG. 6 is a flowchart of a user valuation request.

FIG. 7 is a flowchart of a data stratum update.

FIG. 8 is a flowchart of a table or map creation procedure.

FIG. 9 is a table of property valuations and confidence scores.

FIG. 10a is a valuation comparison map made from the data in FIG. 9 showing the properties and their valuations graphically.

FIG. 10b is a valuation comparison map showing properties and their valuations graphically at a lower level of “zoom.”

FIG. 10c is a valuation comparison map showing properties and their valuations graphically at a still lower level of “zoom.”

FIG. 10d is a valuation comparison map showing properties and their valuations graphically at a very low level of “zoom.”

FIG. 11 is a location merit map.

FIG. 12 is a table of properties and the percentage change of valuations.

FIG. 13a is a map made from the data in FIG. 12 showing the properties and their percentage change in valuation graphically.

FIG. 13b is a map showing properties and their percentage change in valuation graphically at a lower level of “zoom.”

FIG. 13c is a map showing properties and their percentage change in valuation graphically at a very low level of “zoom.”

FIG. 14 is a table of median percentage change in valuations in a predetermined geographic area, namely a zip code.

FIG. 15 is a map made from the data in FIG. 14 showing the median property valuations for the predetermined geographic area.

FIG. 16 is a table of median percentage change in valuations in a predetermined geographic area, namely a set of census tracts.

### DETAILED DESCRIPTION OF THE INVENTION

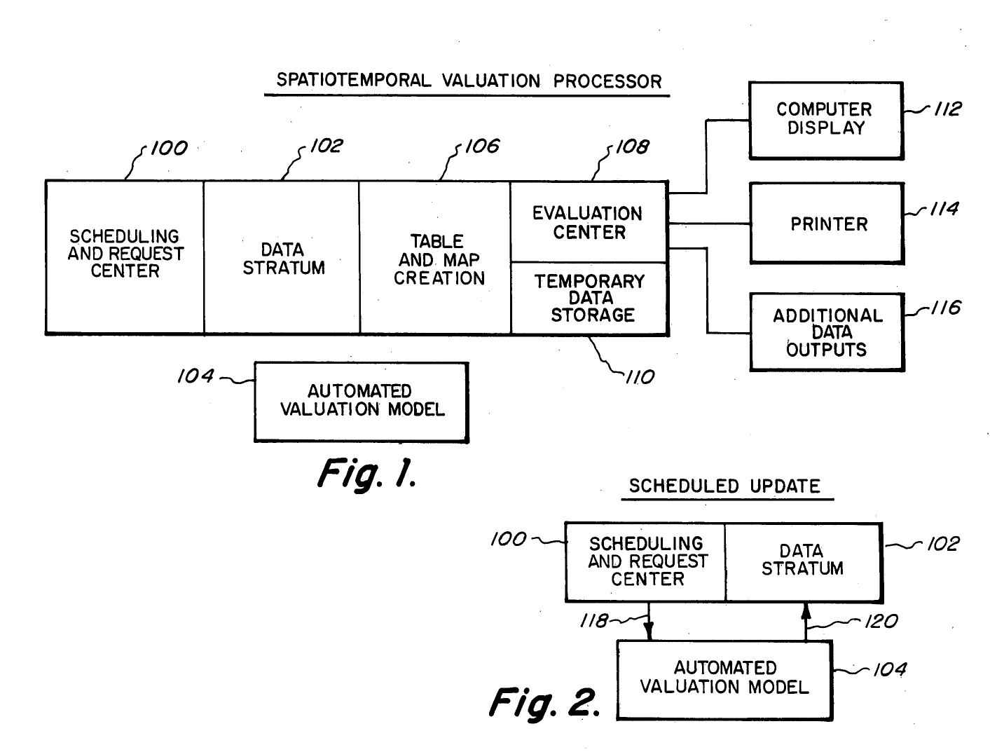

Referring first to FIG. 1, an overview of the spatiotemporal valuation processor is depicted. The scheduling and request center 100 is responsible for maintaining a schedule of the dates and times on which the data stratum 102 will be updated. This schedule is changeable and could be changed by a user with proper authorization. The data stratum 102 is the element of the spatiotemporal valuation processor that maintains valuations of each and every property in a given geographic area. Additionally, the data stratum 102 maintains previous valuations for each and every property in a given geographic area. Each month or time period's set of valuations thus yields a separate layer of the total data stratum 102. When the user requests that a recent valuation be called up, the data stratum 102 is consulted. The table and map creation 106 is used to create tables from the data within the data stratum 102. When the user requests that a table or map be created, the table and map creation 106 parses the data and fills tables to display to the user or from which maps can be made. The evaluation center 108 can take input from the user requesting the table or map to be generated. Additionally, it acts as a conduit through which the data displayed as a table or as a map is parsed and is displayed either on a computer display 112, printed on a printer 114 or output through additional data outputs 116. Finally, temporary data storage 110 is used in table and map creation and in modern computer systems could be Random Access Memory (RAM) set aside for processing by the computer's operating system to be used by this program as it is running.

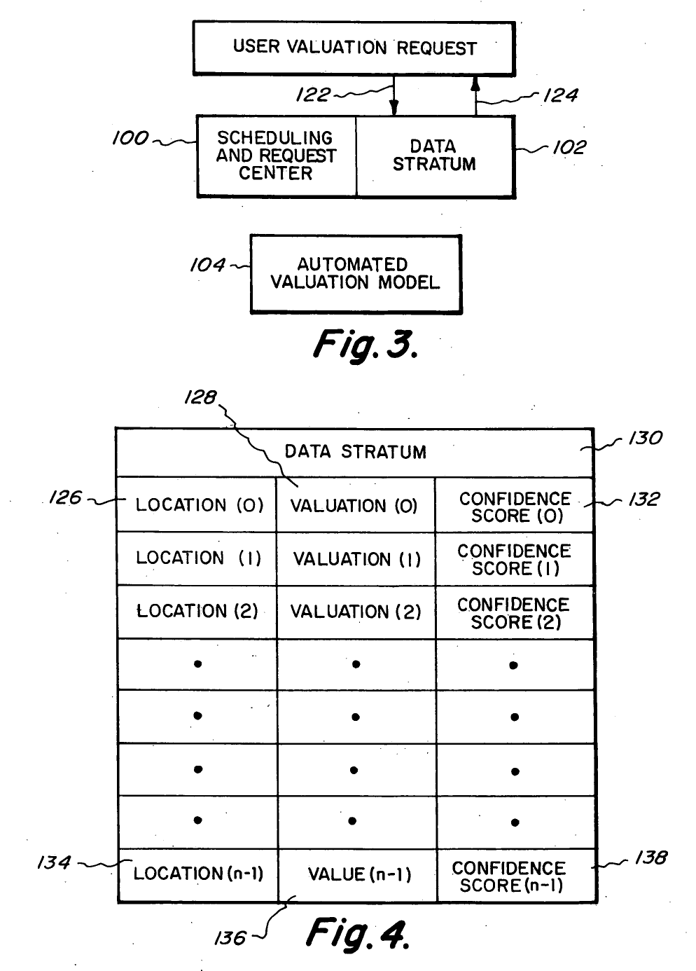

Referring next to FIG. 2, an overview of the preferred embodiment of the scheduled update method is depicted. In the preferred embodiment, the scheduling and request center 100 maintains a schedule of when the next predetermined update to the data stratum 102 is scheduled to occur. This schedule can be altered by an authorized user. The data stratum 102 maintains the current valuations, generated by the automated valuation model 104 at the last scheduled update. When the scheduling and report center 100 triggers a scheduled update it will request a valuation from the automated valuation model 104 for every property in a predetermined geographic area. This geographic area may be any predetermined size such as a zip code, census tract, city, county or state. The automated valuation model 104 generates valuations for every property using sales, appraisals, assessed values, and other commonly accepted sources of data, especially those occurring since the last scheduled update. In alternative embodiments the data stratum 102 may be updated using the above-mentioned commonly accepted sources of data and the data within the data stratum 102 layer from previous scheduled valuations. The automated valuation model 104 returns those valuations and their locations to the data stratum 102 and those new valuations are stored within the data stratum 102.

In the preferred embodiment, these scheduled updates are performed every three months at a minimum. As processors become faster and data storage becomes larger, the number of scheduled updates could increase. Thus, the scheduled updates could eventually be performed once monthly or even once daily, to ensure accurate and up to date valuations.

This method will create valuations for every property in a given geographic area at regular intervals using automated valuation models, any new sales and appraisals and other commonly accepted sources of valuation data in the geographic area. This data stratum with complete valuations for each property in a geographic area can be used to provide quick and accurate valuations for that property. Because of the predetermined updates, the user will be assured that the valuation is always up-to-date. Additionally, each layer or more than one layer of the data stratum can be used to create tables and maps based on the information contained within it.

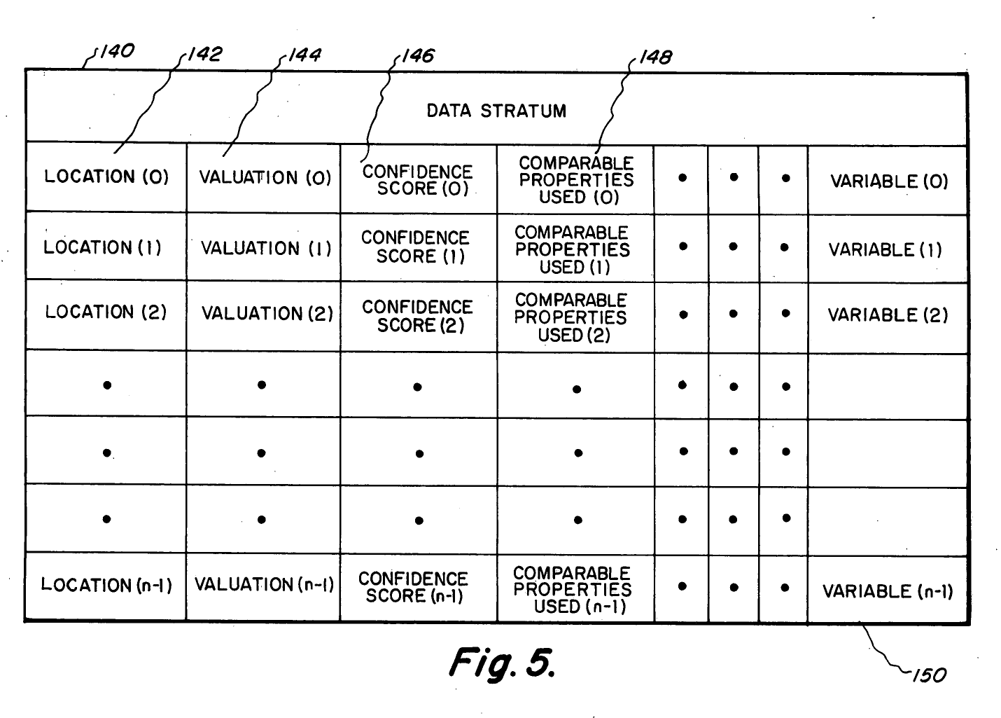

Referring next to FIG. 3, an example user valuation request is depicted. In this example, the first step is the valuation request 122, whereby the user requests a valuation of the target property. Because the data stratum 102 contains a recent valuation of every property within the target geographic area, there is no need, at least initially, to make any valuation request to the automated valuation model 104. No connection is needed, unless the user desires to receive a full valuation, for example, including documentation and comparable sales information from the automated valuation model 104. In FIG. 3, the valuation request 122 is made directly to the data stratum 102. The valuation stored in the data stratum 102 will be returned to the user in valuation response 124. This action happens at electronic speed and at only the cost of the computer processing time necessary to make the valuation request 122 and return the valuation response 124. After the user receives the valuation from the data stratum 102, the user could, through direct means or through clicking on an interactive map, make a full valuation request to automated valuation model 104.

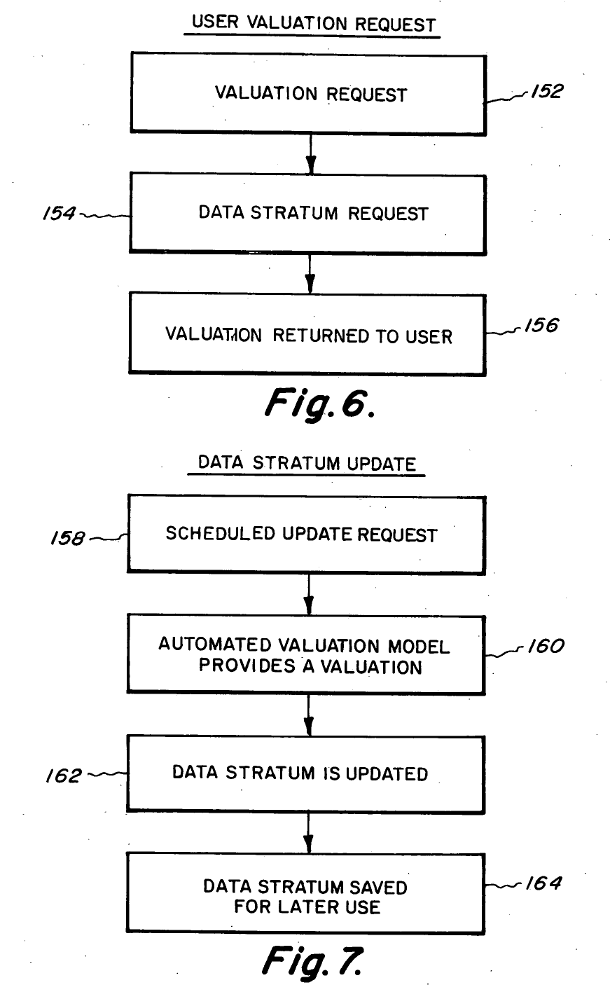

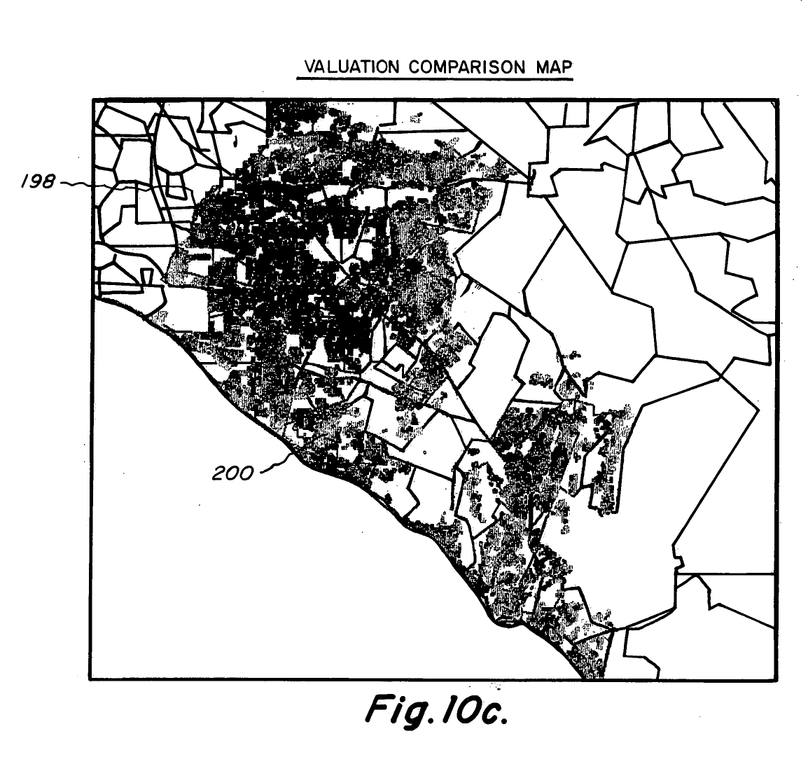

Referring next to FIG. 4, the contents of an example data stratum 130 are depicted. This table contains the location, the valuation, and the confidence score for each valuation of each property. A confidence score is a measure of the automated valuation model's confidence in the accuracy of each of its valuation. For example, for property(0), where 0 is the index of the property within the data stratum, there is a location(0) 126, a valuation(0) 128 and a confidence score(0) 132. Each row of the table would contain the same variables for every property in the data stratum 130. The table will have indices from 0 to n−1 where n is the number of properties in the given geographic region. Therefore, the data stratum 130 will contain the location and valuation for each property in the geographic region from location(0) 126, valuation(0) 128, confidence score(0) 132 to location(n−1) 134, valuation(n−1) 136, confidence score (n−1) 138. This data stratum 130 can be used in any number of ways, such as the creation of the tables and maps depicted in FIGS. 9, 10, 11, and 12. It can also be used to evaluate the accuracy of the algorithms within the automated valuation model used to create the data stratum or to evaluate later data stratum layers in comparison to each other.

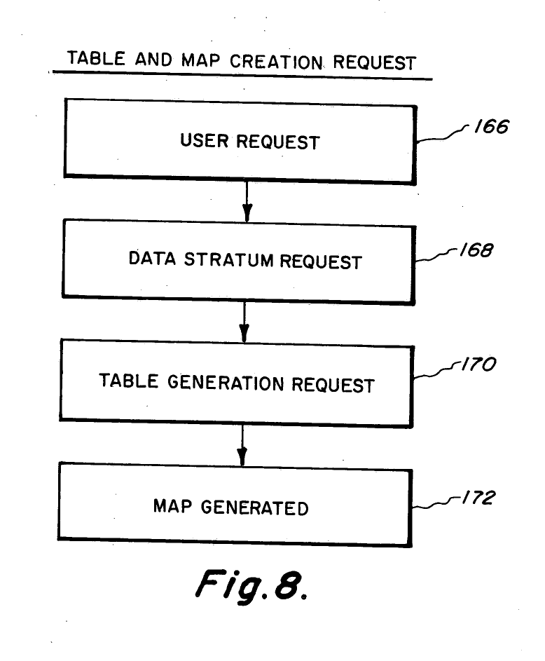

Referring next to FIG. 5, a potential future data stratum layer embodiment is depicted. Again, this data stratum contains locations and valuations for each property in the geographic region, but also contains other useful valuation information about each property. One example of such useful information would be the comparable properties used by the automated valuation model to value each property. In this example data stratum 140 not only are there location (0) 142, valuation(0) 144 and confidence score(0) 146 variables, where 0 is the index within the table of the first property, but additional variables may be included, such as mentioned above, for example the comparable properties used(0) 148 which is a representation of the comparable properties used in the valuation. Additional variables can be used such as exemplified in variable(n−1) 150. These variables could include anything important to a user during the valuation or loan-decision making process.

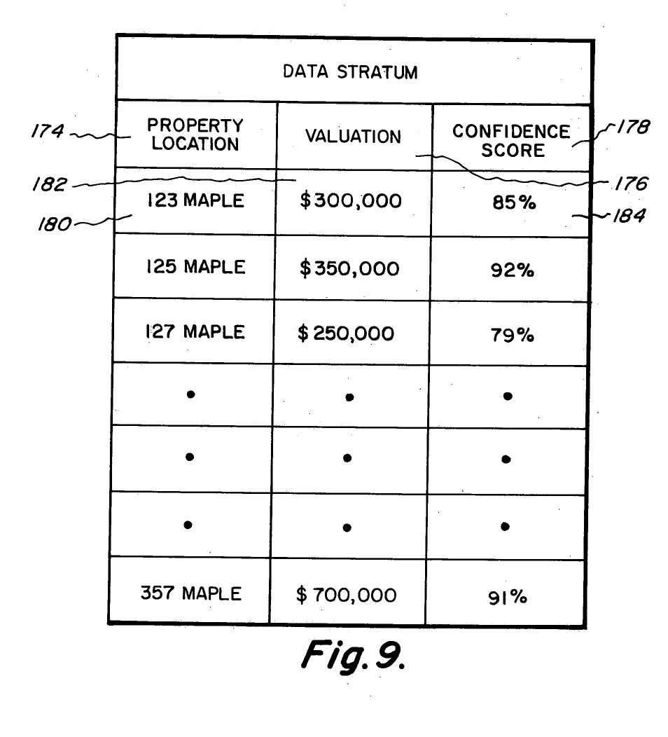

Referring next to FIG. 6, an example user valuation request flowchart is depicted. This flowchart demonstrates the typical user valuation request using the preferred method. Under this method, the user first makes a valuation request 152. The valuation request 152 need not be made to an outside automated valuation model because the data stratum already contains up-to-date valuations of every property in the geographic area. Therefore, the property is found in the data stratum request 154 and in the final step, the valuation is returned to the user 156.

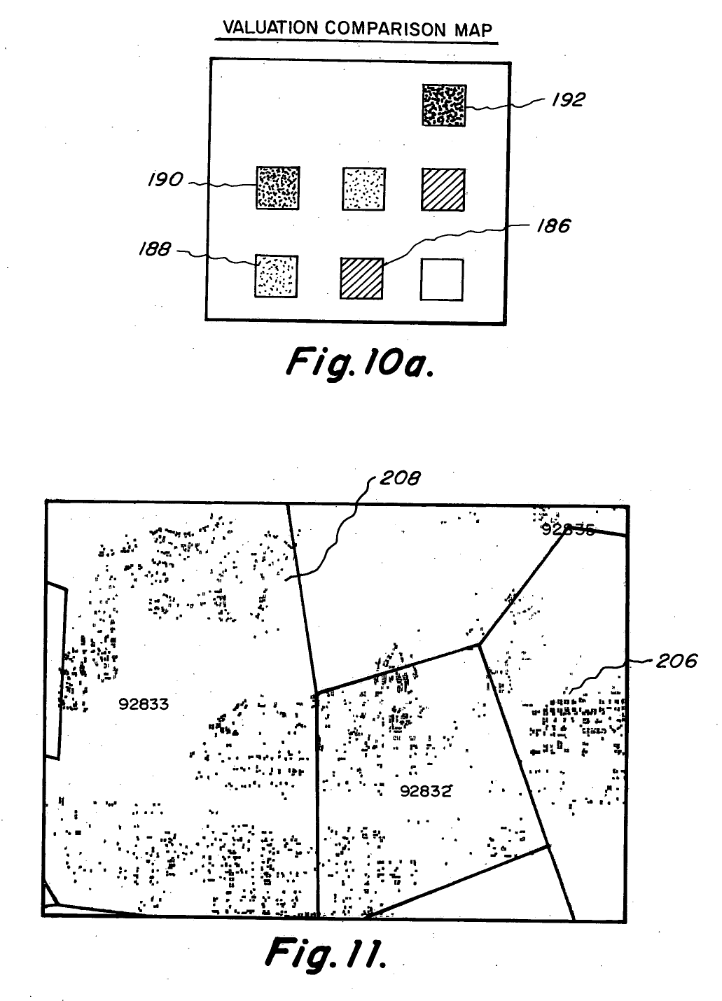

Referring next to FIG. 7, an example data stratum update is depicted. In the first step, the scheduled update request 158 is made. This request will be based upon a predetermined schedule set by an authorized user. The scheduled update request 158 requests a new valuation for every property in the geographic region from the automated valuation model. In the second step, the automated valuation model provides a valuation 160 for each requested property and in the third step the data stratum is updated 162 with the new valuations for every property in the geographic region. Finally, the data stratum is saved for later use 164. This entire operation is repeated at each of the predetermined intervals.

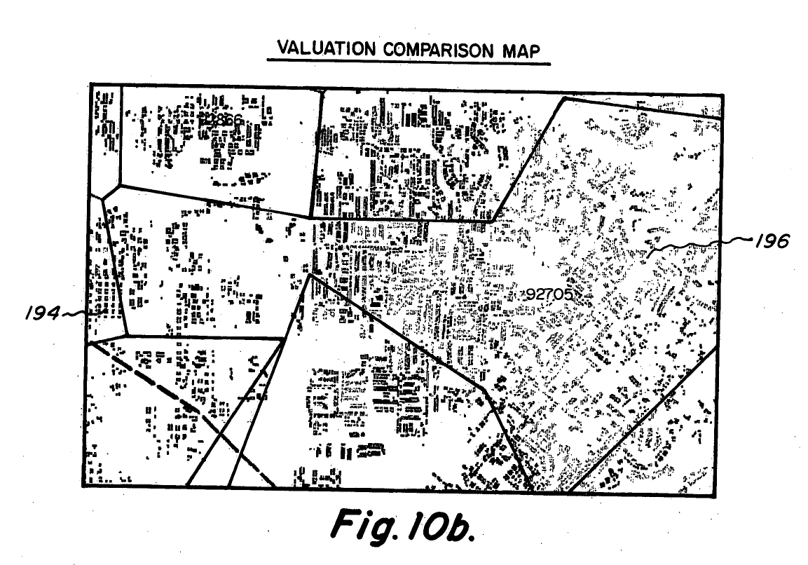

Referring next to FIG. 8, a table and map creation request is depicted. In the first step of this process, a user request 166 is made. The user request could be for the creation of a table, spreadsheet or map of the relevant data or for a map depicting the relative valuations in a given geographic area. Alternatively, the request could be for a table, spreadsheet or map depicting the change in the valuation of properties in a given geographic area. These tables, spreadsheets or maps could report information on individual properties or they could report information on a collective basis such as the median valuation in a zip code or census tract. Once the request is made, the information is taken from the data stratum through a data stratum request 168. A table generation request 170 is made by the evaluation center 108 (see FIG. 1) with the data stratum data using the table and map creation 106 (see FIG. 1). Finally, if requested by the user, the table is used in generating a map 172. In the final step, when requested by the user, a graphical map is created.

This map would be displayed on a computer display 112 (see FIG. 1) and could be dynamic, such that a user could highlight an area to “zoom in” on or a single home to value. The map could also be color coded to visually depict valuations or change in valuation since the last data stratum update. Alternative embodiments could include non-interactive versions, small zip-code or county-sized maps fixed in a tangible medium, smaller interactive versions for zip-codes or counties, and non-interactive computer-displayed versions of the various possible maps. These could be printed on the printer 114 or output by other means through the additional data outputs 116 envisioned in FIG. 1.

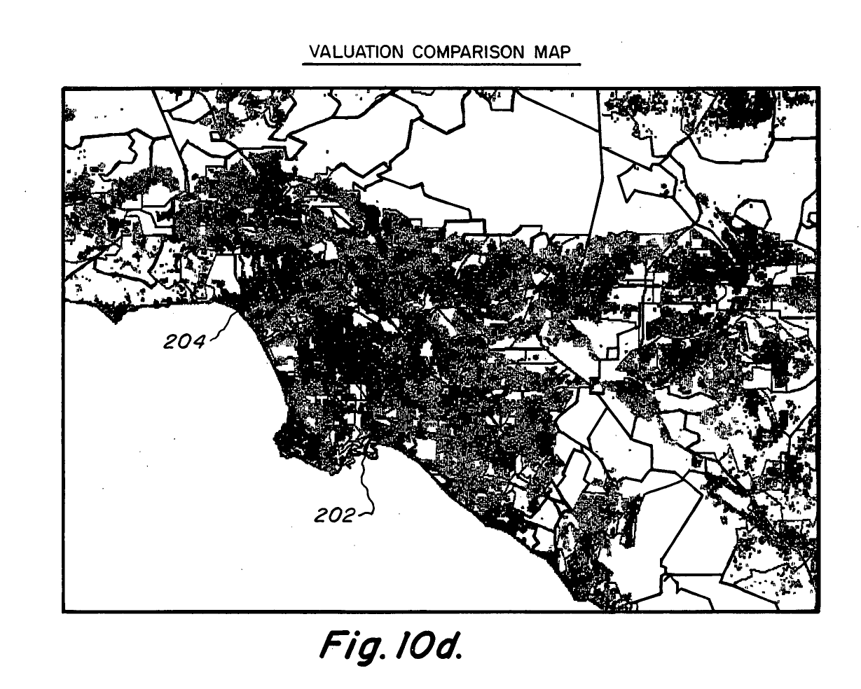

Referring next to FIG. 9, an example table created from the data stratum is depicted. This table created from the data stratum contains all of the information for the current data stratum layer: the property location 174, the valuation 176, and the confidence score 178 of the automated valuation model used to do the valuation. The specific property location in element 180 is 123 Maple with the valuation in element 182 of $300,000 and with a confidence score in element 184 of 85. This is one example of the contents of a complete record for a single property. The data contained in the table in FIG. 9 may be used in the creation of maps like the example graphical map depicted in FIG. 10.

Referring now to FIGS. 9 and 10a, 10b, 10c, and 10d in the valuation-based map of FIG. 10a, the example property is depicted as property 186. The shading represents a comparison of the valuations of properties within a geographic area. Lighter shaded properties, like property 188, would have lower valuations. Darker shaded properties, like property 190, would have higher valuations. Even darker shaded properties, like property 192, would be even more valuable still. In the preferred embodiment, color-coding would be used. Alternatively, shading, as depicted here, or cross hatching may be used to prepare the maps. These maps may be given on an individual basis—showing individual properties and mapping them on individual blocks of individual streets, a far higher level of precision than is possible in the prior art—or on a collective basis—showing zip codes or census tracts as units and displaying mean or median valuation numbers.

Using FIGS. 10a, 10b, 10c, or 10d, a user could spot disproportionately valued properties. The map in FIG. 10a would be only a subset of maps like those represented in FIGS. 10b, 10c, and 10d. A map, color-coded according to levels of valuation, could be created for a census tract (a geographic area much smaller and more precise than a zip code), zip code, city, county, state or nation. In such maps, a single color-coded dot would represent each property. The aggregation of those dots would create a visual display of the gradations of valuation from area to area, depending on the size of the map. In the preferred embodiment, this map would be presented interactively on a computer screen. This interactive map would allow the user to zoom out from the depiction of FIG. 10a to a city, county or state level. At low levels of “zoom,” the maps would appear as a collection of closely-grouped colors representing different valuations in different geographic areas. FIGS. 10a-10d are examples of various levels of “zoom.” The “zoomed-out” macro-view of a map allows the user to see broadly the areas of high value and of low value. Areas of darker color in high concentration would represent areas of high value, whereas areas of lighter color in high concentration would represent areas of lower value. Potentially, a user at this level could use such maps to spot areas of low value in the midst of high value areas or of high value in the midst of low value areas. These dots could be superimposed on maps of highways and streets or on topographic maps.

Maps at any level of “zoom” could be created. The maps could be created for small areas, such as census tracts or for large areas, such as entire states or nations. Census tract maps or other smaller maps at this level have until now been unavailable. However, because this method values every or almost every property in a predetermined geographic area, a map at any level, including these very high levels of zoom, can be created.

Several examples of various levels of zoom can be seen in FIGS. 10b-10d. In FIG. 10b, a slightly lower level of zoom is depicted. This map is an example zip code level valuation map. At this level of zoom, the user can still see individual houses and streets, but can also begin to see areas of high value, depicted using darker dots, such as element 194. The user can also see areas of low value, depicted using lighter dots, such as element 196. In FIG. 10c, an even lower level of zoom is depicted. This map is an example county level valuation map. At this level of zoom, the user can no longer see individual dots or streets. However, the user can see larger areas of high value, such as element 198 and larger areas of lower value such as element 200. The user could potentially spot a larger area of lower value surrounded by higher valued property. Finally, FIG. 10d depicts a different level of zoom. This map is an example city level valuation map. Larger areas of high value such as element 202 and larger areas of low value such as element 204 can be seen. Maps similar to FIGS. 10b-10d could also be presented with a legend describing the levels of valuation that each color-coded dot represents.

An interactive map could enable the user to “zoom in” on a particular area within the state, county, city, zip code or census tract. Once “zoomed in” the user could click on an individual property to bring up its full automated valuation model valuation or to bring up other property related information. The user could click or highlight an entire area of a map and bring up summary data concerning the average valuation in that area, the average square footage, and average sales price. Alternatively, the user could click on a property to receive any current real estate listing and asking price for the selected property.

Additionally, maps at any level of zoom could be created using successive iterations of the data stratum to demonstrate changes in the values of homes in a predetermined geographic area such as a census tract, zip code, city, county, state or nation over time. These maps could be of the individual properties or of all of the properties within a geographic area on a collective basis. These maps could be displayed together in relatively rapid succession to create a movie-like presentation of changes in property values. These movie-maps would be useful in spotting numerous trends in the real estate market.

The data contained in tables like FIG. 9 may be used to create “location merit” tables or maps. In these tables or maps, the property features are “frozen” so that all properties with similar features are compared solely based upon their location. This enables a user to understand to what extent the property value is based upon location merit. For example, the user could request to see only valuations for residences from 1500 to 2000 square feet with lot sizes from 5,000 to 10,000 square feet in a particular city. The table created from the data stratum lists only the homes that meet such criteria and provides only their valuations.

Alternatively, this table could be created from all properties in a geographic area that meet such criteria on a collective basis. This table would only contain homes that met such criteria. The collective basis table would, for example, display the median valuation of all homes, meeting such criteria in a given geographic area. Using these tables and maps, the user can then see at what addresses or other geographic areas the location is an important factor in determining value.

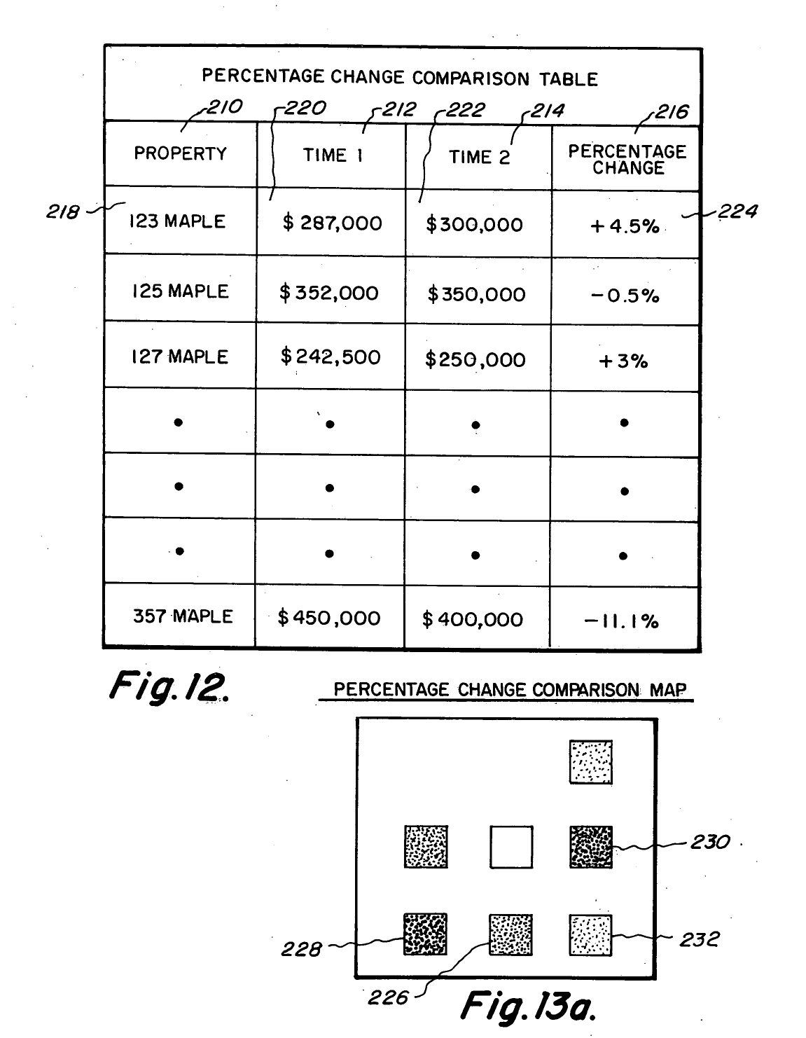

Referring next to FIG. 11, maps may also be made from this data. These maps could be of individual homes or of geographic areas compiled on a collective basis. A map made from a location merit table would only include houses that met the freeze criteria and could then be quickly reviewed to see locations of high location merit and low location merit. FIG. 11 presents an example location merit map. All of the properties represented on this map meet certain freeze criteria and, with respect to those criteria, are substantially the same. The map is more sparsely populated than the map in FIGS. 10b-d because only the freeze criteria properties are depicted. Using this map, an individual could see that homes near element 206 have a higher location merit than maps near element 208. Because the homes are substantially the same, only the location of the home is being taken into account in the comparison of valuation.

A collective basis map could also be created. This type of map would only include in its median valuation for a given geographic area, those properties which met the freeze criteria. Alternatively, the location merit-type maps could freeze any characteristic of a properties or properties on a collective basis. Alternative freeze criteria could include: lot size, number of bathrooms, a range of asking prices, or a range of ages of the properties. Location merit-like tables and maps could be created in much the same way as the regular “location merit” maps are created.

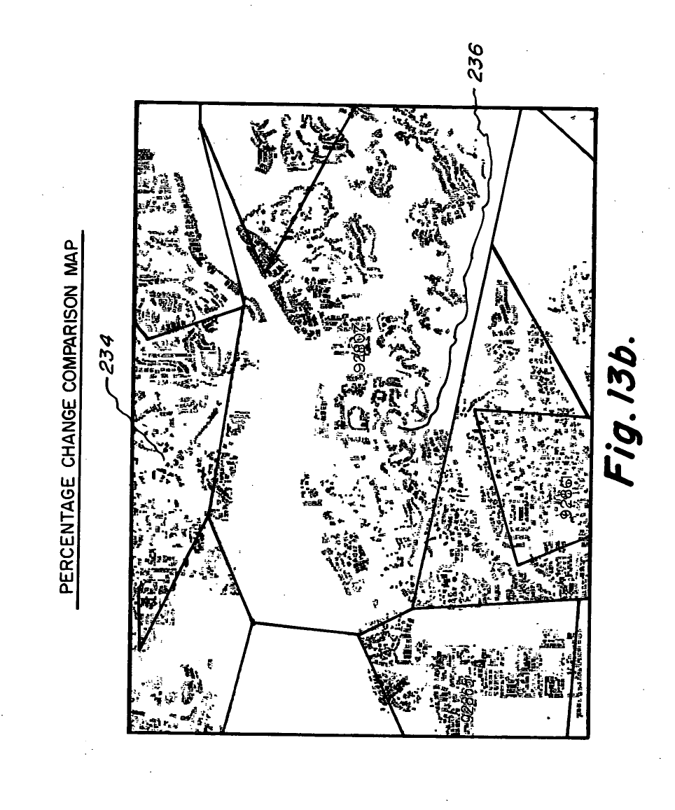

Referring next to FIG. 12, a table created using a current data stratum and the most recent past data stratum is depicted. In FIG. 12, the property 210 is shown along with time 1 in element 212, time 2 in element 214, the percentage change in valuation 216. For example, property 123 Maple in element 218 has a valuation at time 1 depicted in element 220 of $287,000 and a valuation at time 2, depicted in element 222, of $300,000 for a percentage change in valuation, depicted in element 224, of +4.5%. The property and its change in valuation can be compared, using a table such as that in FIG. 12, to other properties within a given area. This ability will enable the user to determine quickly which properties have increased in valuation and which properties have decreased in valuation in the period between scheduled updates and by what amount. Additionally, erratic fluctuations in value, seen over time or over space, may be used to reveal and thus to correct any errors in the underlying automated valuation model. Abrupt spatial or temporal “terraces” in value, such as what might be seen when crossing a street or zip code boundary, might be examined to see whether they represent genuine differences in location merit or represent a quirk in the design of the automated valuation model.

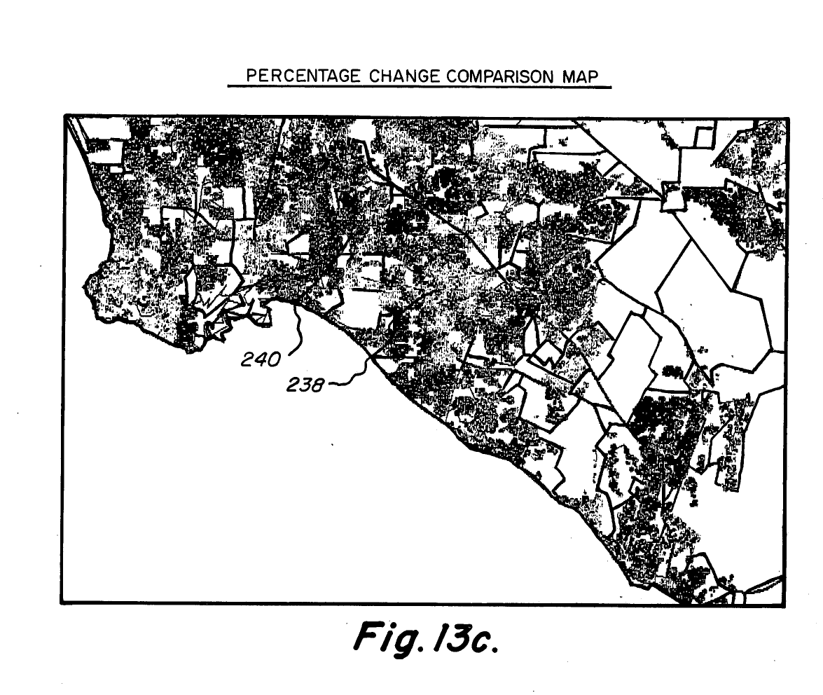

Referring next to FIG. 13a, 13b, and 13c, a graphical representation may also be made of the percentage changes in valuations. In FIG. 13a, 123 Maple, from element 218 in FIG. 12, is depicted as property 226. Its change in valuation was only 4.5%, so it is lightly shaded. Properties such as property 218 and property 230 are more darkly shaded because the percentage change in valuation is larger than that of property 226. Alternatively, property 232 is more lightly shaded than property 226, therefore its percentage change in valuation is less than that of property 226. This map is different from the previous map described in FIG. 10 in that this map represents percentage changes in valuation from one iteration of the data stratum to the next. The maps in FIGS. 13a-c depict changes in valuation in comparison to those of other properties, whereas the maps in FIGS. 10a-d depict actual valuations in comparison to those of other properties or other geographic area median values. These graphical depictions are preferably in color. Alternatively, these maps may be prepared using cross-hatching. Each color or cross-hatching pattern would represent a certain range of changes in property valuation since the last scheduled data stratum update.

The map depicted in FIG. 13a is only a subset of a map of an entire census tract, zip code, city, county, state or country. As with the valuation maps, until now maps showing levels of zoom such as census tracts have been impossible. Because the method of this invention values every or almost every property in a predetermined geographic area, maps at any level of zoom, including even census tracts, can be created.

The maps depicted in FIGS. 13b and 13c are examples of such “zoomed out” maps. FIG. 13b primarily depicts an entire zip code's percentage change in valuation. FIG. 13c depicts an entire county's percentage change in valuation. The individual homes on the larger maps would be represented by a single colored dot representing its percentage change in valuation. At a high level of “zoom out,” a user could spot levels of low value or change in value in the midst of high value or change in value, or vice versa. For example, element 236 in FIG. 13b is an area of lighter shading. This shading represents the fact that a lower percentage change in value has occurred in that area. Element 234, however, is an area that has experienced more substantial percentage change in value, as evidenced by its darker shading. The same is true for maps at lower levels of “zoom.” The properties in FIG. 13c near element 240 have experienced a larger percentage change in value than those near element 238. As above, these maps could be for any level of “zoom” such as individual properties, census tracts, cities, zip codes, or states and could show mean or median valuations. The user could compile a series of these maps for each iteration of the data stratum update and create a movie-like presentation of the percentage change in value for the given region. This would be useful in spotting changes in the market and numerous types of property value trends.

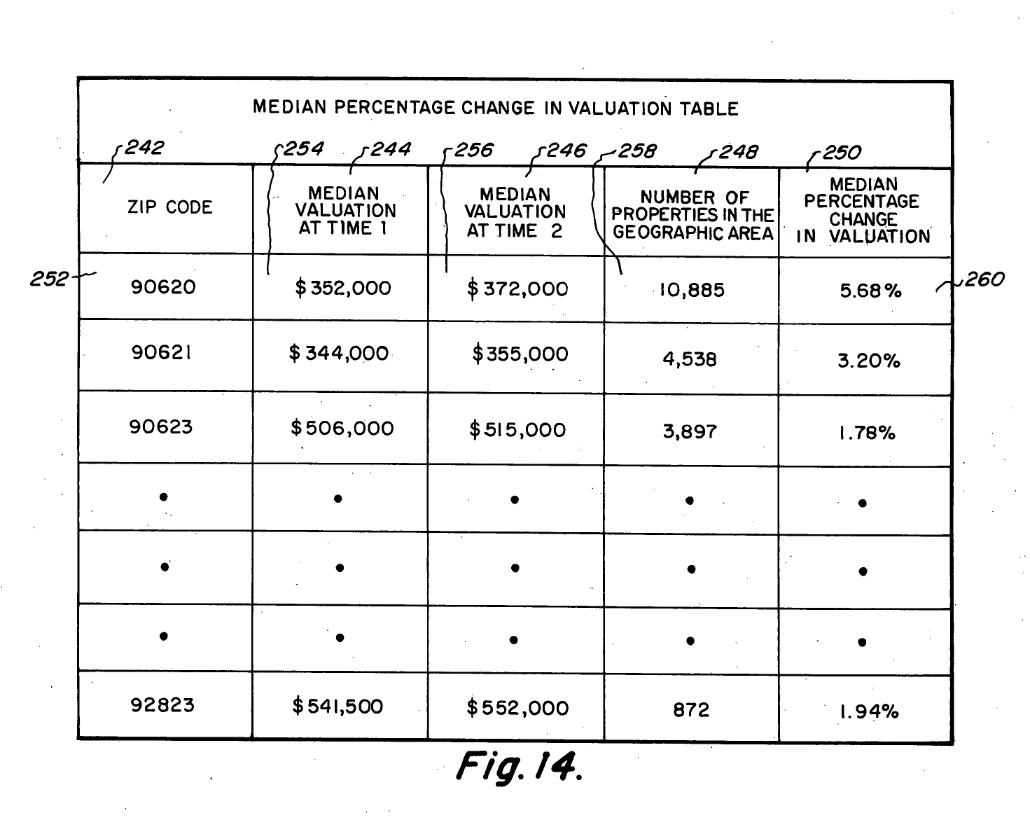

Referring next to FIG. 14, an aggregate or collective basis table of each zip code in geographic area is depicted. The collective basis chosen in FIG. 14 is zip code. Therefore, in this table, each of the properties in the zip code is used in arriving at a single median valuation for that zip code. Alternatively, mean valuations could also be used. In FIG. 14, there is shown a zip code 242 median valuation at time 1 in element 244, median valuation at time 2 in element 246 number of valued properties in the geographic area 248, and median percentage change in valuation 250 depicted. Because the method of this invention provides a valuation for every or almost every property in a geographic area, the zip code 242 could also be replaced with census tract, county, city, or state. This would provide median valuations and changes in valuations for each of the various levels of abstraction. In an alternative embodiment, a mean change in valuation could be used.

Because of the law of averages, the accuracy of these collective basis percentage change in valuations can be assured. If, for example, the automated valuation model used continuously values all properties lower than actual value, this will be immaterial to the change in value calculation because the median or mean change in value will still be accurate when the automated valuation model again values the properties lower than actual value. Alternatively, should the automated valuation model value some properties too high and some properties too low, the law of averages will result in no net effect on the collective basis data, once the two cancel each other out. Therefore, the accuracy of this collective basis data can be assured to be very high.

In FIG. 14, the aggregate data from the data stratum is used on a higher level of abstraction than those of the individual properties in FIGS. 9 and 12 to enable the user to detect trends at a higher, more general level. In the example shown in FIG. 14, the zip code in element 252 is 90620. In zip code 252 the median valuation at time 1 is depicted in element 254 and was $352,000. The median valuation at time 2, depicted in element 256, is $372,000. The number of properties in the geographic area, depicted in element 258, is 10,885. Therefore, based on the change in valuation, the median percentage change in valuation 260 is 5.68%. This means that the median value for homes in that zip code increased by 5.68% between the two iterations of the data stratum. The sample size of 10,885 represents virtually all properties in zip code 252, not simply the properties that actually sold or were appraised. This provides a far more accurate index of change in value. In addition, the set of sold or appraised properties may not represent a full and unbiased selection of the housing stock in an area. This problem is solved in the present invention by valuing all the properties in an area, whether they sold or not.

Because the number of properties valued far exceeds the number of properties sold during a month or quarter, and far exceeds the number of properties that can be appraised at a reasonable expenditure, the present invention makes it possible to construct tables of mean or median valuation, or change in valuation, for areas much smaller than a zip code, such as a census tract.

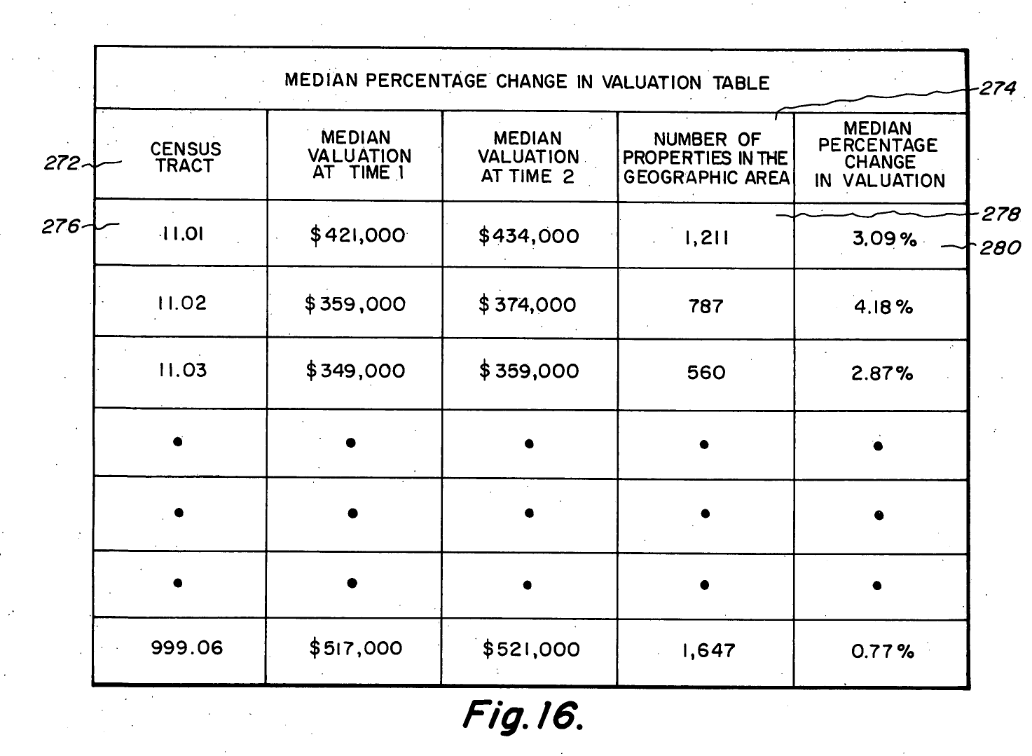

FIG. 16 represents such a table. In this figure, the first column, element 272 is a list of census tracts. The remaining columns are the same as in the zip code version depicted in FIG. 14. In column 274, the Number of Properties in the Geographic Area, the numbers are all considerably smaller in this table than in that of FIG. 14. This is because census tracts are considerably smaller geographic areas. However, because the method of this invention values every or almost every property in the geographic area this invention is able to provide tables and maps for such small areas. For example, census tract 11.01 depicted in element 276 only contains 1,211 properties as depicted in element 278. The median percentage change in valuation, depicted in element 280 is 3.09% based upon this small number of properties in this small geographic area. This is a major improvement in spatial precision over the prior art which was simply not possible using existing methods based on prices of a relatively small number of sold properties or the values of a relatively small number of appraisals.

Maps could also be compiled based on the data in FIG. 14 or FIG. 16, in a similar fashion to those of FIGS. 10a-c and 13a-c representing each census tract, zip code, city, county or state as a single color-coded dot or area. Using the law of averages, as mentioned above, these collective basis data could be assured of accuracy. These color-coded maps could be interactive, based upon a computer via the web or some other medium. The user could click on individual dots of, for example, a zip code and the image would “zoom in” to that zip code providing a new map of each home in that zip code represented by an individual color-coded dot. The broad tables depicted in FIG. 14 and the maps based thereon could be used by a user to spot broader trends at a higher level of abstraction than the individual neighborhood such as entire geographic areas losing value in their property or entire geographic areas gaining value.

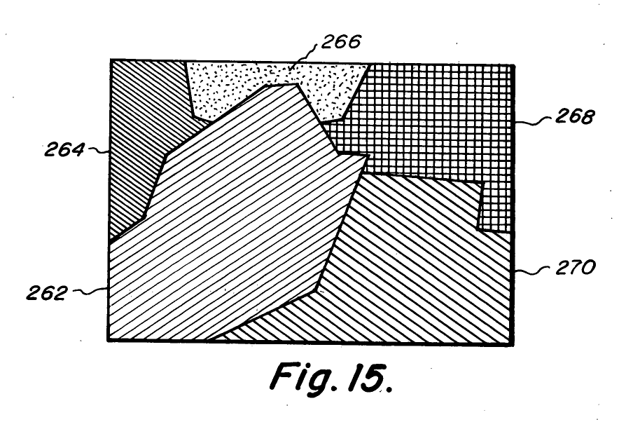

Referring next to FIGS. 14 and 15, a map based upon the median valuations in a given geographic area from FIG. 14 are depicted. Zip code 252 90620 is depicted in area 262. Darker areas, such as areas 264, 268 and 270 are higher in median valuations. Lighter areas, such as area 266 are lower in median value. The user can determine, at a very high level of abstraction, the median valuation of homes in a larger area based upon the aggregation of the data stratum into census tracts, zip codes, cities, counties or states. In FIG. 15, the area 262 represents a zip code, but in alternative embodiments, the area could be a census tract as in FIG. 16, a city, county or state.

Referring next to FIGS. 1, 9, 10a-d, 12, 13a-c, 14 15, and 16 the maps described above and depicted in FIGS. 10a-d, 13a-c and 15 could be used to further refine the automated valuation model used to perform the valuations for the data stratum 102. The evaluation center 108 could be used in this method or it could be done by an individual user, while reviewing the data in tabular (See FIGS. 9, 12, 14, and 16) or graphical (See FIGS. 10a-d, 13a-c, and 15) form. This method would use the data stratum 102 to refine the algorithms used by the automated valuation model 104 to choose more closely comparable properties in its valuations of homes. The data stratum 102, because it evaluates every property in a target area, could be used to find homes more closely comparable to other homes in a target area. Use of only the most similar properties as comparable properties by the automated valuation model 104 would enable its valuations to become increasingly more accurate.

Alternatively, an evaluation could take place visually. A user, referring to a data stratum 102, tables created therefrom (See FIGS. 9, 12, 14, and 16) or maps (See FIGS. 10a-d, 13a-c and 15) of valuations could be used to spot strong lines or other marks of differing valuation or other considerations, such as hilly areas. These lines or hilly areas could demark some unusual aspect of the way in which the automated valuation model 104 chooses comparable properties. Modification of this unusual algorithmic consideration would enable the automated valuation model 104 to be more accurate.

For example, an automated valuation model could be improved using this method by not choosing “comparable” properties (comps) in an area of strongly differing valuation from a subject property, even though these comps were physically nearby—for instance, if they were up in a hilly area while the subject property was in a flat and less desirable area. An automated valuation model could be improved by encouraging it to choose comps across zip code boundaries where that was appropriate. Other applications and improvements based upon these tables and maps are also possible.

It will be apparent to those skilled in the art that the present invention may be practiced without these specifically enumerated details and that the preferred embodiment can be modified so as to provide other capabilities. The foregoing description is for illustrative purposes only, and that various changes and modifications can be made to the present invention without departing from the overall spirit and scope of the present invention. The full extent of the present invention is defined and limited only by the following claims.

What is claimed is:

1. A computer-based method of providing valuations for each property in a predetermined geographic area comprising the steps of:
evaluating each property in said predetermined geographic area using an automated valuation model, and
reevaluating each property in said predetermined geographic area at predetermined time intervals using an automated valuation model.

2. The method of claim 1, wherein the automated valuation model used for each property in said predetermined geographic area is the same automated valuation model used for reevaluation of each property in the geographic area.

3. The method of claim 1, wherein said predetermined time intervals are equal periods of time.

4. The method of claim 1 further comprising the step of preparing a table of said predetermined geographic area with valuation indicia thereon corresponding to the valuation of each subject property in said predetermined geographic area.

5. The method of claim 1 further comprising the step of preparing a map of said predetermined geographic area with valuation indicia thereon corresponding to the valuation of each subject property in said predetermined geographic area.

6. The method of claim 5, wherein said map is on a graphic medium.

7. The method of claim 5, wherein said map is color-coded.

8. The method of claim 5, wherein said map is displayed on a computer screen.

9. The method of claim 8, wherein said display on said computer screen is interactive to enable access to information about each property in said predetermined geographic area.

10. The method of claim 1 further comprising the step of preparing a map of said predetermined geographic area with valuation indicia thereon corresponding to data represented on a collective basis.

11. The method of claim 10, wherein said map is on a graphic medium.

12. The method of claim 10, wherein said map is color-coded.

13. The method of claim 10, wherein said map is displayed on a computer screen.

14. The method of claim 1, further comprising the step of evaluating at least one of the automated valuation models used in the method.

15. The method of claim 1, further comprising the step of isolating properties within the predetermined geographic area that meet predetermined criteria.

16. The method of claim 15, further comprising the step of evaluating only said isolated properties in relation to each other.

17. The method of claim 16, further comprising the step of preparing a table of said predetermined geographic area with valuation indicia thereon corresponding to the valuation of said isolated properties in said predetermined geographic area.

18. The method of claim 16, further comprising the step of preparing a map of said predetermined geographic area with valuation indicia thereon corresponding to the valuation of said isolated properties in said predetermined geographic area.

19. A computer-based method of computing the rate of change of valuations for each property in a predetermined geographic area comprising the steps of:
evaluating each property in said predetermined geographic area at predetermined time intervals using an automated valuation model, and
computing the rate of change of value of each property in said predetermined geographic area between said predetermined time intervals.

20. The method of claim 19 further comprising the step of preparing a table of said predetermined geographic area with valuation indicia thereon corresponding to the valuation of each subject property in said predetermined geographic area.

21. The method of claim 19 further comprising the step of preparing a map of said predetermined geographic area with rate of change of valuation indicia thereon corresponding to the rate of change of valuation of each subject property in said predetermined geographic area.

22. The method of claim 21, wherein said map is on a graphic medium.

23. The method of claim 22, wherein said map is color-coded.

24. The method of claim 21, wherein said map is displayed on a computer screen.

25. The method of claim 19, further comprising the step of preparing a map of said predetermined geographic area with valuation indicia thereon corresponding to the rate of change of valuation of each property represented on a collective basis.

26. The method of claim 1, further comprising the step of using said valuations for each property in said predetermined geographic area to evaluate at least one automated valuation model.

27. The method of claim 1, further comprising the step of using a map of said valuations for each property in said predetermined geographic area to evaluate at least one automated valuation model.

28. A computer-based apparatus for providing valuations for each property in a predetermined geographic area comprising:
means for evaluating each property in said predetermined geographic area using an automated valuation model, and
means connected to said evaluating means to activate said evaluating means to reevaluate each property in said predetermined geographic area at predetermined time intervals using an automated valuation model.

29. The apparatus of claim 26, wherein the automated valuation model used for each property in the geographic area is the same automated valuation model used for reevaluation of each property in said predetermined geographic area.

30. The apparatus of claim 26, wherein said predetermined time intervals are equal periods of time.

31. The apparatus of claim 26 further comprising means connected to said evaluating means for preparing a table of evaluations in said predetermined geographic area with valuation indicia thereon corresponding to the valuation of each subject property in said predetermined geographic area.

32. The apparatus of claim 26 further comprising means connected to said evaluating means for preparing a map of evaluations in said predetermined geographic area with valuation indicia thereon corresponding to the valuation of each subject property in said predetermined geographic area.

33. The apparatus of claim 30, further comprising means connected to said evaluating means for displaying said map on a graphic medium.

34. The apparatus of claim 30, wherein said map is color-coded.

35. The apparatus of claim 30, further comprising computer screen displays means connected to said evaluating means for displaying said map.

36. The apparatus of claim 31, wherein said computer screen display means includes means to enable a user to access information about each property in said predetermined geographic area on an interactive basis.

37. The apparatus of claim 26 further comprising means connected to said evaluating means for preparing a map of said predetermined geographic area with valuation indicia thereon corresponding to data represented on a collective basis.

38. The apparatus of claim 35, wherein said map preparing means includes means for displaying valuation indicia on a graphic medium.

39. The apparatus of claim 36, wherein said map displaying means includes means for displaying a color-coded map.

40. A computer-based apparatus for computing the rate of change of valuations for each property in a predetermined geographic area comprising:
means for evaluating each property in said predetermined geographic area at predetermined time intervals using an automated valuation model, and
means connected to said evaluating means for computing the rate of change of value of each property in said predetermined geographic area between said predetermined time intervals.

41. The apparatus of claim 38 further comprising map preparation means connected to said evaluating means and further connected to said means for computing the rate of change of value for preparing a map of said predetermined geographic area with rate of change of valuation indicia thereon corresponding to the rate of change of valuation of each subject property in said predetermined geographic area.

42. The apparatus of claim 39, wherein said map preparation includes means for preparing a map on a graphic medium.

43. The apparatus of claim 40, wherein said map preparation means includes means for preparing a color-coded map.

44. The apparatus of claim 41, further comprising computer screen display means connected to said map preparation means to display said map on said computer screen display means.

45. The apparatus of claim 42 further comprising automated valuation model evaluation means connected to said means for evaluating each property for evaluating at least one of the automated valuation models used in the method by said means for evaluating each property.

46. The apparatus of claim 43, wherein said automated valuation model evaluation means includes means for comparing the valuation of at least one property in the geographic area produced by said evaluated automated valuation model with sales of a plurality of comparable properties in said predetermined geographic area.
